(19) United States
(12) Patent Application Publication
(10) Pub. No.: US 2013/0110309 A1
(43) Pub. Date: May 2, 2013

(54) VEHICLE COLLISION AVOIDANCE AND MITIGATION SYSTEM

(71) Applicants: J. William Whikehart, Milford, MI (US); Debra A. Bezzina, Livonia, MI (US)

(72) Inventors: J. William Whikehart, Milford, MI (US); Debra A. Bezzina, Livonia, MI (US)

(73) Assignee: VISTEON GLOBAL TECHNOLOGIES, INC., Van Buren Township, MI (US)

(21) Appl. No.: 13/286,419

(22) Filed: Nov. 1, 2011

(51) Int. Cl. G06F 7/00

(52) U.S. Cl. 701/1

(57) ABSTRACT

A system which jointly reduces damage from an impending collision between multiple vehicles includes sensing devices, at least one processor, at least one memory, output devices, and communication devices. The sensing devices sense conditions near, around, in, or involving multiple vehicles. The at least one memory is in electronic communication with the at least one processor, and includes programming code for execution by the at least one processor. The programming code is configured to analyze the sensed conditions sensed by the sensing devices to jointly determine and output instructions to multiple vehicles for jointly reducing damage from an impending collision between them. The output devices output or implement the jointly determined output instructions to multiple vehicles. The communication devices communicate the sensed conditions from the sensing devices to the at least one processor, and communicate the jointly determined output instructions from the at least one processor to the output devices.

### FIELD OF THE DISCLOSURE

The disclosure relates to systems and methods for jointly reducing damage from an impending collision between multiple vehicles.

### BACKGROUND OF THE DISCLOSURE

Some systems exist in which a vehicle uses sensors in communication with a processor to determine a collision avoidance plan to reduce the likelihood of a collision of the vehicle with other vehicles, structures around the vehicle, or pedestrians. These systems may only use the sensor data from the vehicle itself without gathering other sensor data such as sensor data from other vehicles. These systems may also only determine a collision avoidance plan for the vehicle itself without jointly determining a joint collision avoidance plan for all vehicles which may be involved in the collision. Other systems may jointly determine a joint collision avoidance plan for all vehicles which may be involved in the collision, in an effort to avoid the collision all-together, but may not determine a joint collision damage reduction plan for all vehicles which will reduce damage actually resulting from the occurrence of a collision.

A system and method is needed to reduce or resolve one or more issues of one or more of the existing systems.

### SUMMARY OF THE DISCLOSURE

In one embodiment, a system is disclosed for jointly reducing damage from an impending collision between multiple vehicles. The system comprises sensing devices, at least one processor, at least one memory, output devices, and communication devices. The sensing devices are for sensing conditions near, around, in, or involving multiple vehicles. The at least one memory is in electronic communication with the at least one processor. The at least one memory comprises programming code for execution by the at least one processor. The programming code is configured to analyze the sensed conditions sensed by the sensing devices to jointly determine and output instructions to multiple vehicles for jointly reducing damage from an impending collision between them. The output devices are for outputting or implementing the jointly determined output instructions to multiple vehicles. The communication devices are for communicating the sensed conditions from the sensing devices to the at least one processor, and for communicating the jointly determined output instructions from the at least one processor to the output devices.

In another embodiment, a method is disclosed for jointly reducing damage from an impending collision between multiple vehicles. In one step, conditions are sensed near, around, in, or involving multiple vehicles using sensing devices. In another step, the sensed conditions are communicated from the sensing devices to at least one processor using at least one communication device. In an additional step, the sensed conditions communicated from the sensing devices to the at least one processor are analyzed, using programming code stored in at least one memory and executed by the at least one processor, to jointly determine output instructions for the multiple vehicles to jointly reduce damage from an impending collision between them. In yet another step, the jointly determined output instructions are communicated, using the at least one communication device or at least another communication device, from the at least one processor to output devices of the multiple vehicles. In another step, the communicated jointly determined output instructions are outputted, using the output devices of the multiple vehicles, to jointly reduce damage from an impending collision between them.

These and other features, aspects and advantages of the disclosure will become better understood with reference to the following drawings, description and claims.

### BRIEF DESCRIPTION OF THE DRAWINGS

FIG. 1 illustrates a box diagram of a system for jointly reducing damage from an impending collision between multiple vehicles; and

FIG. 2 illustrates is a flowchart illustrating one embodiment of a method for jointly reducing damage from an impending collision between multiple vehicles.

### DETAILED DESCRIPTION OF THE DISCLOSURE

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims. It is noted that the Figures are purely for illustrative purposes and are not to scale.

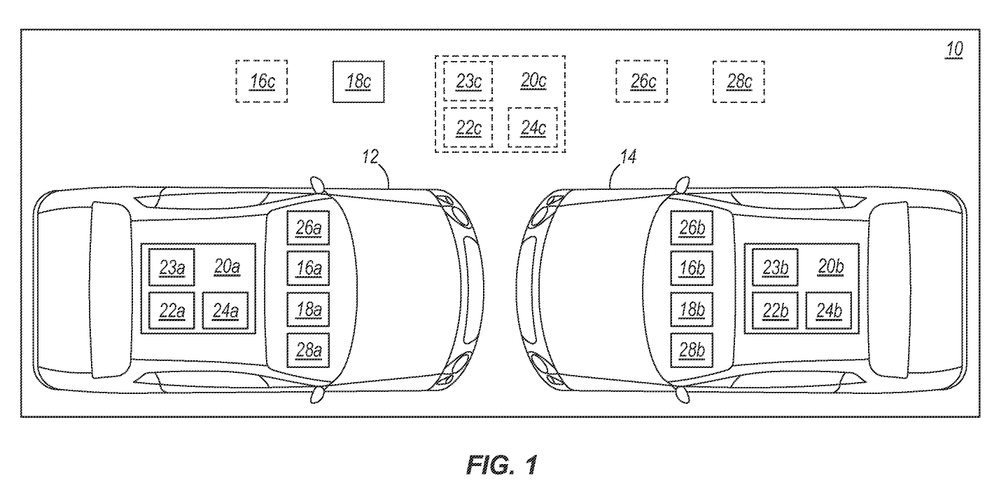

FIG. 1 illustrates a box diagram of a system 10 for jointly reducing damage from an impending collision between multiple vehicles 12 and 14. Although the vehicles 12 and 14 may still collide, the system 10 will jointly reduce the damage resulting from the collision. The vehicles 12 and 14 may comprise any type of vehicles for transporting people or animals such as cars, busses, or other types of vehicles. The system 10 may jointly reduce damage from the impending collision to the multiple vehicles 12 and 14, to occupants in the multiple vehicles 12 and 14, or to people, animals, buildings, or other structures located in the vicinity of the multiple vehicles 12 and 14.

The system 10 comprises vehicles 12 and 14, sensing devices 16a and 16b, processors 20a and 20b in communication with memories 22a and 22b and databases 23a and 23b, output devices 26a and 26b, and communication devices 28a and 28b. The sensing devices 16a and 16b are for sensing conditions 18a, 18b, or 18c near, around, in, or involving the multiple vehicles 12 and 14. Sensing device 16a comprises a portion of vehicle 12. Sensing device 16b comprises a portion of vehicle 14. Optionally, sensing device 16c may be located outside of vehicles 12 and 14. The sensing devices 16a and 16b and optional sensing device 16c comprise at least one of a camera, a laser device, a radar device, or another type of sensing device for sensing conditions 18a, 18b, or 18c near, around, in, or involving the multiple vehicles 12 and 14. The condition 18a is a condition in or of vehicle 12. The condition 18b is a condition in or of vehicle 14. The condition 18c is a condition of the environment outside of vehicles 12 and 14.

The conditions 18a, 18b, or 18 sensed by the sensing devices 16a and 16b, or optional sensing device 16c, comprise at least one of a weather condition, a pavement condition, vehicle positions, vehicle speeds, vehicle directions, vehicle accelerations, vehicle decelerations, a traffic light condition, a structure location, a building location, a person location, an obstacle location, vehicle occupant locations, vehicle air bag information, or vehicle seat-belt information.

Processor 20a is located in or on vehicle 12 and is in electronic communication with memory 22a, memory 22b, or optional memory 22c, and with database 23a, database 23b, or with optional database 23c. Memory 22a comprises programming code, for execution by processor 20a, which is configured to analyze the sensed conditions 18a, 18b, or 18c sensed by sensing devices 16, 16b, or optional sensing device 16c, and the data in databases 23a and 23b, or optional database 23c, to jointly determine and output instructions 24a, 24b, or optional instructions 24c, to vehicles 12 and 14 for jointly reducing damage from an impending collision between them.

The data in databases 23a, 23b, or in optional database 23c may comprise at least one of vehicle handling capabilities, vehicle crash testing data, vehicle impact data as to where ideal locations are for vehicle impact, vehicle frame structure information, vehicle energy absorption information, or other types of data

Processor 20b is located in or on vehicle 14 and is in electronic communication with memory 22a, memory 22b, or optional memory 22c and with database 23a, database 23b, or with optional database 23c. Memory 22b comprises programming code, for execution by processor 20b, which is configured to analyze the sensed conditions 18a, 18b, or 18c sensed by sensing devices 16, 16b, or optional sensing device 16c, and the data in databases 23a and 23b, or optional database 23c, to jointly determine and output instructions 24a, 24b, or optional instructions 24c, to vehicles 12 and 14 for jointly reducing damage from an impending collision between them.

Optional processor 20c may be located outside of or apart from vehicles 12 and 14 and may be in electronic communication with memory 22a, memory 22b, or optional memory 22c and with database 23a, database 23b, or optional database 23c. Optional memory 22c comprises programming code, for execution by optional processor 20c, which is configured to analyze the sensed conditions 18a, 18b, or 18c sensed by sensing devices 16, 16b, or optional sensing device 16c, and the data in databases 23a and 23b, or optional database 23c, to jointly determine and output instructions 24a, 24b, or optional instructions 24c, to vehicles 12 and 14 for jointly reducing damage from an impending collision between them.

The processors 20a, 20b, or optional processor 20c, may communicate with one another, the memories 22a, 22b, or optional memory 22c, and the databases 23a, 23b, or optional database 23c, and act jointly together in concert to jointly determine and output the instructions 24a, 24b, or optional instructions 24c, to vehicles 12 and 14 for jointly reducing damage from an impending collision between them. In other embodiments, any number of the processors 20a, 20b, or optional processor 20c may determine and output the instructions 24a, 24b, or optional instructions 24c to vehicles 12 and 14 to jointly reduce damage to vehicles 12 and 14 from an impending collision between them.

The jointly determined output instructions 24a, 24b, or optional instructions 24c, may comprise at least one of vehicle steering control instructions, vehicle speed control instructions, vehicle braking instructions, vehicle sound instructions, vehicle light instructions, vehicle audio instructions, vehicle display instructions, vehicle air bag instructions, vehicle seat belt instructions, vehicle energy absorption instructions, traffic light instructions, instructions for an external vehicle output device, or instructions for another type of output device.

Output devices 26a, 26b, or optional output device 26c are for outputting or implementing the jointly determined output instructions 24a, 24b, or optional output instructions 24c, to vehicles 12 and 14. Output devices 26a, 26b, or optional output device 26c, comprise at least one of vehicle steering control devices, vehicle speed control devices, vehicle braking devices, vehicle sound devices, vehicle light devices, vehicle audio devices, vehicle display devices, vehicle air bag devices, vehicle seat belt devices, vehicle energy absorption devices, a traffic light device, an external vehicle output device, or another type of output device. Output device 26a comprises a portion of vehicle 12. Output device 26b comprises a portion of vehicle 14. Optional output device 26c may be located outside of vehicles 12 and 14 for outputting or implementing the jointly determined output instructions 24a, 24b, or optional instructions 24c, to people or devices located outside of vehicles 12 and 14. For instance, the optional output device 26c may comprise a traffic light device, an external vehicle output device, or another type of output device.

Communication devices 28a and 28b, or optional communication device 28c, are for communicating the sensed conditions 18a, 18b, or 18c from the sensing devices 16, 16b, or optional sensing device 16c, to the processors 20a, 20b, or optional processor 20c. Communication devices 28a and 28b, or optional communication device 28c, are also for communicating the jointly determined output instructions 24a and 24b, or optional output instructions 24c, from the processors 20a and 20b, or optional processor 20c, to the output devices 26a and 26b, or optional output device 26c. Communication devices 28a, 28b, or optional communication device 28c, may comprise a wireless communication device, a satellite, the internet, or another type of communication device. Communication device 28a comprises a portion of vehicle 12. Communication device 28b comprises a portion of vehicle 14. Optional communication device 28c may be located outside of vehicles 12 and 14.

In other embodiments, the system 10, including all of the system's components, may vary in quantity, size, configuration, orientation, actual components, or function.

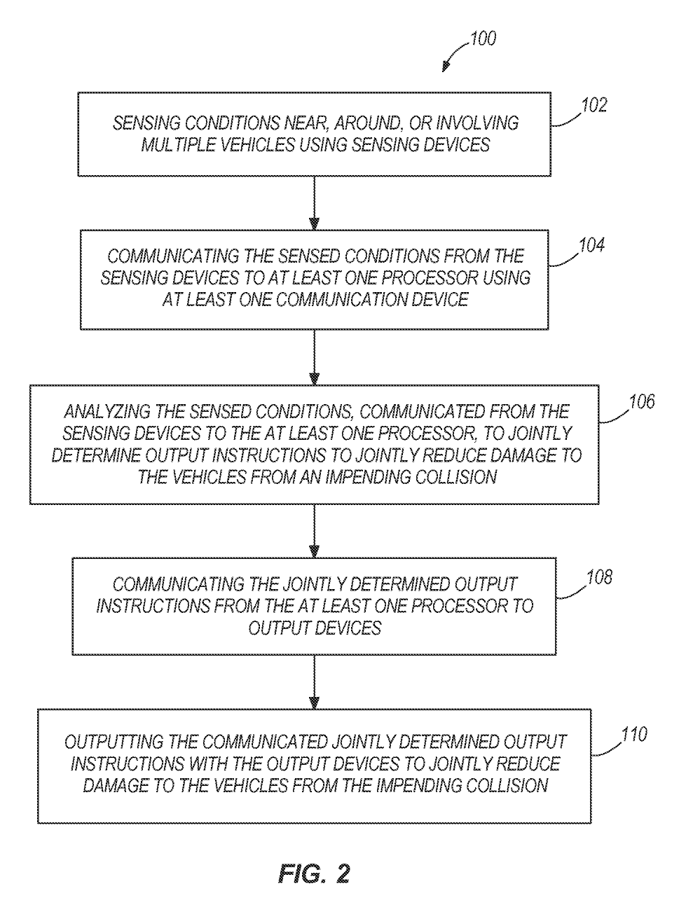

FIG. 2 is a flowchart illustrating one embodiment of a method 100 for jointly reducing damage from an impending collision between multiple vehicles. In step 102, conditions near, around, or involving multiple vehicles is sensed using sensing devices. In one embodiment, the sensing devices comprise at least one of a camera device, a laser device, or a radar device. In another embodiment, the conditions sensed by the sensing devices comprise at least one of a weather condition, a pavement condition, vehicle positions, vehicle speeds, vehicle directions, vehicle accelerations, vehicle decelerations, a traffic light condition, a structure location, a building location, a person location, an obstacle location, vehicle occupant locations, vehicle air bag information, or vehicle seat-belt information.

In step 104, the sensed conditions are communicated from the sensing devices to at least one processor using at least one communication device. In one embodiment, the at least one communication device comprises at least one of a wireless communication device, a satellite, or an internet. In step 106, the sensed conditions communicated from the sensing devices to the at least one processor are analyzed, using programming code stored in at least one memory and executed by the at least one processor, to jointly determine output instructions for the multiple vehicles to jointly reduce damage from an impending collision between them.

In one embodiment, step 106 may further comprise analyzing data stored in at least one database, in communication with the at least one processor, using the programming code stored in the at least one memory and executed by the at least one processor, to jointly determine the output instructions for the multiple vehicles to jointly reduce the damage from the impending collision between them. The data stored in the at least one database may comprise at least one of vehicle handling capabilities, vehicle crash testing data, vehicle impact data as to where ideal locations are for vehicle impact, vehicle frame structure information, vehicle energy absorption information, or other types of data. In another embodiment, the jointly determined output instructions may comprise at least one of vehicle steering control instructions, vehicle speed control instructions, vehicle braking instructions, vehicle sound instructions, vehicle light instructions, vehicle audio instructions, vehicle display instructions, vehicle air bag instructions, vehicle seat belt instructions, vehicle energy absorption instructions, traffic light instructions, instructions for an external vehicle output device, or instructions for another type of output device.

In step 108, the jointly determined output instructions are communicated, using the at least one communication device or at least another communication device, from the at least one processor to output devices. In one embodiment, the communication devices comprise at least one of wireless communication devices, a satellite, or an internet. The output devices may comprise portions of the multiple vehicles or may be disposed outside of the vehicles. In one embodiment, the output devices comprise at least one of vehicle steering control devices, vehicle speed control devices, vehicle braking devices, vehicle sound devices, vehicle light devices, vehicle audio devices, vehicle display devices, vehicle air bag devices, vehicle seat belt devices, vehicle energy absorption devices, a traffic light device, or an external vehicle output device. In step 110, the communicated jointly determined output instructions are outputted, using the output devices, to jointly reduce damage to the vehicles from an impending collision between the vehicles.

In one embodiment, the multiple vehicles comprise the sensing devices, the output devices, the communication devices, and the at least one processor. In another embodiment, the at least one processor comprises separate processors of each of the multiple vehicles communicating with one another and acting jointly to jointly determine the output instructions for jointly reducing damage from the impending collision between the vehicles. In still another embodiment, each of the multiple vehicles comprises at least one of the sensing devices, at least one of the output devices, at least one of the communication devices, and at least one of the at least one processor. In an additional embodiment, the multiple vehicles comprise the sensing devices, the output devices, and the communication devices, and one or more of the at least one processor is located apart from the vehicles.

One or more embodiments of the disclosure may reduce one or more issues of one or more of the existing systems by jointly determining a joint plan for multiple vehicles to reduce damage from an impending collision between them. These embodiments may rely on sensor data from multiple vehicles to determine the joint plan. Further, these embodiments may jointly determine a joint plan for multiple vehicles to jointly reduce the damage which results to the vehicles from an actual collision between them. In still other embodiments, one or more additional issues of the existing art may be reduced or resolved.

It should be understood, of course, that the foregoing relates to exemplary embodiments of the disclosure and that modifications may be made without departing from the spirit and scope of the disclosure as set forth in the following claims.

We claim:

1. A system for jointly reducing damage from an impending collision between multiple vehicles comprising:
sensing devices for sensing conditions near, around, in, or involving multiple vehicles;
at least one processor;
at least one memory in electronic communication with the at least one processor, wherein the at least one memory comprises programming code for execution by the at least one processor, and the programming code is configured to analyze the sensed conditions sensed by the sensing devices to jointly determine and output instructions to multiple vehicles for jointly reducing damage from an impending collision between them;
output devices for outputting or implementing the jointly determined output instructions to multiple vehicles; and
communication devices for communicating the sensed conditions from the sensing devices to the at least one processor and for communicating the jointly determined output instructions from the at least one processor to the output devices.

2. The system of claim 1 further comprising multiple vehicles, wherein the multiple vehicles comprise the sensing devices, the output devices, the communication devices, and the at least one processor.

3. The system of claim 2 wherein the at least one processor comprises separate processors of each of the multiple vehicles communicating with one another and acting jointly to jointly determine and output the instructions to the multiple vehicles for jointly reducing damage from an impending collision between them.

4. The system of claim 2 wherein each of the multiple vehicles comprises at least one of the sensing devices, at least one of the output devices, at least one of the communication devices, and at least one of the at least one processor.

5. The system of claim 1 further comprising at least one database in electronic communication with the at least one processor, wherein the programming code is configured to additionally analyze data contained in the at least one database to jointly determine and output the instructions to the multiple vehicles for jointly reducing the damage from the impending collision between them.

6. The system of claim 5 wherein the data contained in the at least one database comprises at least one of vehicle handling capabilities, vehicle crash testing data, vehicle impact data as to where ideal locations are for vehicle impact, vehicle frame structure information, or vehicle energy absorption information.

7. The system of claim 1 wherein the sensing devices comprise at least one of a camera device, a laser device, or a radar device.

8. The system of claim 1 wherein the conditions sensed by the sensing devices comprise at least one of a weather condition, a pavement condition, vehicle positions, vehicle speeds, vehicle directions, vehicle accelerations, vehicle decelerations, a traffic light condition, a structure location, a building location, a person location, an obstacle location, vehicle occupant locations, vehicle air bag information, or vehicle seat-belt information.

9. The system of claim 1 wherein the jointly determined output instructions comprise at least one of vehicle steering control instructions, vehicle speed control instructions, vehicle braking instructions, vehicle sound instructions, vehicle light instructions, vehicle audio instructions, vehicle display instructions, vehicle air bag instructions, vehicle seat belt instructions, vehicle energy absorption instructions, traffic light instructions, instructions for an external vehicle output device, or instructions for another type of output device.

10. The system of claim 1 wherein the output devices comprise at least one of vehicle steering control devices, vehicle speed control devices, vehicle braking devices, vehicle sound devices, vehicle light devices, vehicle audio devices, vehicle display devices, vehicle air bag devices, vehicle seat belt devices, vehicle energy absorption devices, a traffic light device, or an external vehicle output device.

11. The system of claim 1 wherein the communication devices comprise at least one of wireless communication devices, a satellite, or an internet.

12. A method for jointly reducing damage from an impending collision between multiple vehicles comprising:
sensing conditions near, around, in, or involving multiple vehicles using sensing devices;
communicating the sensed conditions from the sensing devices to at least one processor using at least one communication device;
analyzing the sensed conditions communicated from the sensing devices to the at least one processor, using programming code stored in at least one memory and executed by the at least one processor, to jointly determine output instructions for the multiple vehicles to jointly reduce damage from an impending collision between them;
communicating the jointly determined output instructions, using the at least one communication device or at least another communication device, from the at least one processor to output devices of the multiple vehicles; and
outputting the communicated jointly determined output instructions, using the output devices of the multiple vehicles, to jointly reduce damage from an impending collision between them.

13. The method of claim 12 wherein the multiple vehicles comprise the sensing devices, the output devices, the communication devices, and the at least one processor.

14. The method of claim 13 wherein the at least one processor comprises separate processors of each of the multiple vehicles communicating with one another and acting jointly to jointly determine the output instructions to the multiple vehicles for jointly reducing damage from the impending collision between them.

15. The method of claim 13 wherein each of the multiple vehicles comprises at least one of the sensing devices, at least one of the output devices, at least one of the communication devices, and at least one of the at least one processor.

16. The method of claim 12 wherein the using the programming code stored in the at least one memory and executed by the at least one processor, to jointly determine the output instructions for the multiple vehicles to jointly reduce the damage from the impending collision between them further comprises analyzing data contained in at least one database, in electronic communication with the at least one processor, to jointly determine and output the instructions to the multiple vehicles for jointly reducing the damage from the impending collision between them.

17. The method of claim 16 wherein the data contained in the at least one database comprises at least one of vehicle handling capabilities, vehicle crash testing data, vehicle impact data as to where ideal locations are for vehicle impact, vehicle frame structure information, or vehicle energy absorption information.

18. The method of claim 12 wherein the sensing devices comprise at least one of a camera device, a laser device, or a radar device.

19. The method of claim 12 wherein the conditions sensed by the sensing devices comprise at least one of a weather condition, a pavement condition, vehicle positions, vehicle speeds, vehicle directions, vehicle accelerations, vehicle decelerations, a traffic light condition, a structure location, a building location, a person location, an obstacle location, vehicle occupant locations, vehicle air bag information, or vehicle seat-belt information.

20. The method of claim 12 wherein the jointly determined output instructions comprise at least one of vehicle steering control instructions, vehicle speed control instructions, vehicle braking instructions, vehicle sound instructions, vehicle light instructions, vehicle audio instructions, vehicle display instructions, vehicle air bag instructions, vehicle seat belt instructions, vehicle energy absorption instructions, traffic light instructions, instructions for an external vehicle output device, or instructions for another type of output device.

21. The method of claim 12 wherein the output devices comprise at least one of vehicle steering control devices, vehicle speed control devices, vehicle braking devices, vehicle sound devices, vehicle light devices, vehicle audio devices, vehicle display devices, vehicle air bag devices, vehicle seat belt devices, vehicle energy absorption devices, a traffic light device, or an external vehicle output device.

22. The method of claim 12 wherein the communication devices comprise at least one of wireless communication devices, a satellite, or an internet.
